(19) United States
(12) Patent Application Publication
(10) Pub. No.: US 2024/0078685 A1
(43) Pub. Date: Mar. 7, 2024

(54) METHOD FOR GENERATING FILE INCLUDING IMAGE DATA AND MOTION DATA, AND ELECTRONIC DEVICE THEREFOR

(71) Applicant: SAMSUNG ELECTRONICS CO., LTD., Suwon-si (KR)

(72) Inventors: Ildo KIM, Suwon-si (KR); Sungoh Kim, Suwon-si (KR); Valeriy Prushinskiy, Suwon-si (KR); Hyungsok Yeo, Suwon-si (KR)

(21) Appl. No.: 18/388,641

(22) Filed: Nov. 10, 2023

Related U.S. Application Data
(63) Continuation of application No. PCT/KR2022/006734, filed on May 11, 2022.

(30) Foreign Application Priority Data
May 11, 2021 (KR) 10-2021-0060728

(51) Int. Cl. G06T 7/246; G06F 16/51; G06T 1/60; H04N 23/45

(52) U.S. Cl. CPC G06T 7/248; G06F 16/51; G06T 1/60; H04N 23/45; G06T 2207/30241

(57) ABSTRACT

An electronic device includes a first image sensor for acquiring image data, a sensor for acquiring motion information about an object included in the image data, a memory, and a processor operatively connected to the first image sensor, the sensor and the memory. The processor can acquire image data at a first rate through the first image sensor, acquire through the at least one sensor and second data on the object at a second rate which is higher than the first rate. The second data corresponds to the image data and the data acquired while the image data is acquired. The processor can further generate a package file including the acquired image data and second data.

### CROSS-REFERENCE TO RELATED APPLICATIONS

This application is a continuation application, claiming priority under § 365(c), of International Application No. PCT/KR2022/006734, filed on May 11, 2022, which is based on and claims the benefit of Korean patent application number 10-2021-0060728 filed on May 11, 2021, in the Korean Intellectual Property Office, the disclosures of which are incorporated by reference herein in their entireties.

### TECHNICAL FIELD

Embodiments disclosed in the present document relate to a method for providing a file including image data and motion data, and an electronic device therefor.

### BACKGROUND ART

A mobile terminal can acquire image data through a camera, perform image processing on the acquired image data, and display a preview image. Also, the mobile terminal does not simply display an image acquired through a lens, but can detect an object in the image, and perform various image processing, based on the detected object.

Also, image data acquired through an image sensor can be stored in a memory in a predetermined file format, or can be managed to be viewed through a functional unit such as a viewer. The image data stored in the predetermined file format as above can be used for later image viewing, image editing, and/or image processing.

### DISCLOSURE OF INVENTION

### Technical Problem

An image file, which is a format in which image data acquired through an image sensor is stored, includes information such as pixel information and RGB values. However, it does not include information about a static state or dynamic state of an object, such as motion information of objects on an image, boundary value information between the objects, and depth information of the objects. Accordingly, even though object information is acquired through a separate device (e.g., a depth sensor), it is not stored or managed together with image data causing poor timeliness when the corresponding information is needed.

A technical problem to be achieved in the present disclosure is not limited to the technical problem mentioned above, and other technical problems not mentioned can be clearly understood by those skilled in the art from a description below.

### Solution to Problem

Various embodiments of the present disclosure provide a method and an electronic device for increasing the efficiency of operation by generating one file that includes both image data and motion information of an object corresponding to the image data.

According to an embodiment, an electronic device may include a first image sensor for acquiring image data, at least one sensor for acquiring motion information about an object included in the image data, a memory, and at least one processor operatively connected to the first image sensor, the at least one sensor and the memory. The at least one processor may acquire image data at a first rate through the first image sensor, acquire, through the at least one sensor, second data on the object at a second rate higher than the first rate, the second data corresponding to the image data and being the data acquired while the image data is acquired, and provide a package file including the acquired image data and second data.

According to an embodiment, an operating method of an electronic device may include the operations of acquiring image data at a first rate through a first image sensor, acquiring, through at least one sensor, second data on an object at a second rate higher than the first rate, and providing a package file including the acquired first data and second data.

According to an embodiment, an electronic device may include a display, and at least one processor operatively connected to the display. The at least one processor may acquire a package file including image data and motion information of an object corresponding to the image data, analyze the package file, and perform image processing on the image data, based on the package file.

### Advantageous Effects of Invention

According to various embodiments disclosed in the present document, the efficiency of operation may be increased. For example, the electronic device can acquire first data at a first rate using a first image sensor, and acquire, second data of an object at a second rate higher than the first rate using at least one object sensor, where the second data corresponds to the first data and the second data is acquired while the first data is acquired. Also, according to various embodiments, the quality of an image may be enhanced by identifying objects in an image and processing the image based on the identified objects.

In addition to this, various effects identified directly or indirectly through the present document may be presented.

### BRIEF DESCRIPTION OF DRAWINGS

FIG. 1 is a diagram illustrating structures of an electronic device and a camera according to an embodiment.

FIG. 2 illustrates a main construction of an electronic device and an external device according to an embodiment.

FIG. 3 illustrates a package file according to an embodiment.

FIG. 4 is a flowchart illustrating a process of providing a package file including image data and data on motion information of an object in an electronic device according to an embodiment.

FIG. 5 is a flowchart illustrating a process of receiving a package file and performing image processing in an electronic device according to an embodiment.

FIG. 6 is a diagram illustrating a process of providing a package file in an electronic device, delivering the package file to an external device, and performing image processing based on a package file received from the external device, according to an embodiment.

FIG. 7 illustrates image editing with respect to a preview image in an electronic device according to an embodiment.

FIG. 8 illustrates editing of one image stored in an electronic device according to an embodiment.

FIG. 9 illustrates editing of a plurality of images stored in an electronic device according to an embodiment.

FIG. 10 is a block diagram of an electronic device in a network environment according to various embodiments.

FIG. 11 is a block diagram illustrating a camera module according to various embodiments.

### BEST MODE FOR CARRYING OUT THE INVENTION

Hereinafter, various embodiments of the present document will be described with reference to the accompanying drawings. However, the present document is not intended to limit specific embodiments, and should be understood to include various modifications, equivalents, and/or alternatives of the embodiments of the present invention.

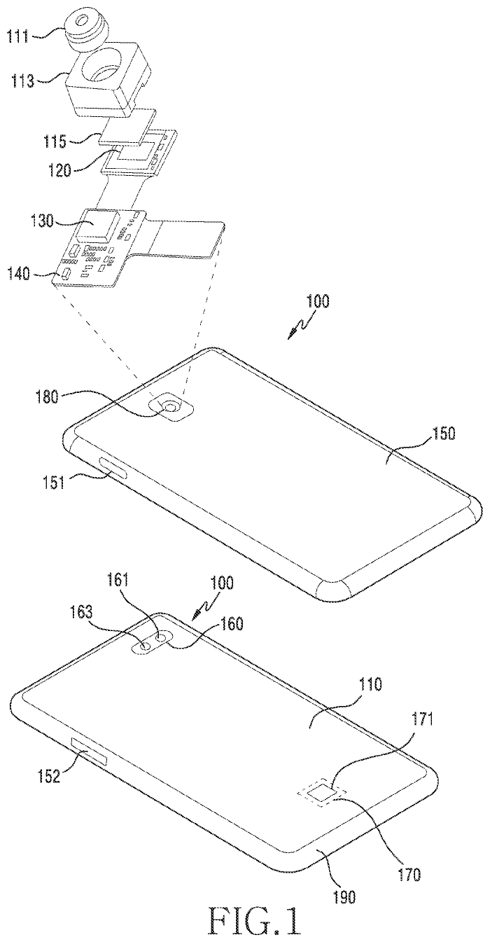

FIG. 1 is a diagram illustrating structures of an electronic device and a camera according to an embodiment.

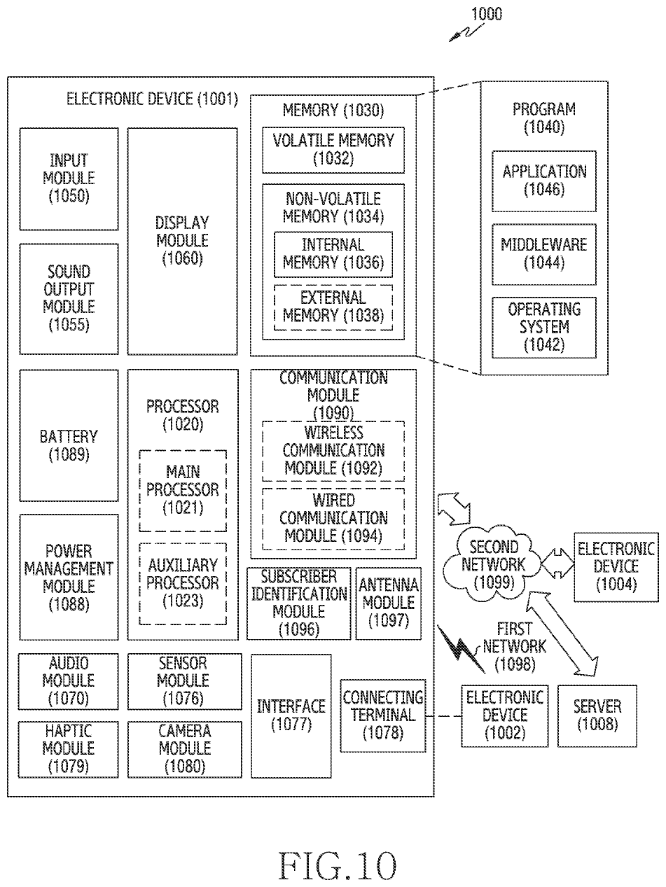

FIG. 1 is a schematic diagram illustrating an appearance of an electronic device (e.g., an electronic device 1001 of FIG. 10) 100 equipped with a camera (e.g., a camera module 1080 of FIG. 10) 180 and the camera 180 according to an embodiment. It will be clearly understood to those skilled in the art that, although the embodiment of FIG. 1 has been illustrated and described on the premise of a mobile device, in particular, a smart phone, it may be applied to an electronic device equipped with a camera among various electronic devices or mobile devices.

Referring to FIG. 1, a display 110 may be disposed on a front surface of the electronic device 100 of one embodiment. In one embodiment, the display 110 may occupy most of the front surface of the electronic device 100. The display 110 and a bezel 190 area surrounding at least some edges of the display 110 may be disposed on the front surface of the electronic device 100. The display 110 may include a flat area, and a curved area extending from the flat area toward a side surface of the electronic device 100. The electronic device 100 shown in FIG. 1 is one example, and various embodiments are possible. For example, the display 110 of the electronic device 100 may include only a flat area without a curved area or may have a curved area only at an edge of one side rather than both sides. Also, in one embodiment, the curved area extends to a rear surface of the electronic device 100, and thus the electronic device 100 may also include an additional flat area.

In one embodiment, the electronic device 100 may additionally include a speaker, a receiver, a front camera, a proximity sensor, a home key, and the like. In the electronic device 100 of one embodiment, a rear cover 150 may be presented integrally with a main body of the electronic device 100. In another embodiment, the rear cover 150 may be separated from the main body of the electronic device 100 and have a form in which a battery may be replaced. The rear cover 150 may also be referred to as a battery cover or a back cover.

In one embodiment, a fingerprint sensor 171 for recognizing a user's fingerprint may be included in a first area 170 of the display 110. Since the fingerprint sensor 171 is disposed on a lower layer of the display 110, the fingerprint sensor 171 may not be recognized by a user or may be difficult to be recognized. Also, in addition to the fingerprint sensor 171, a sensor for additional user/biometric authentication may be disposed in a partial area of the display 110. In another embodiment, a sensor for user/biometric authentication may be disposed in one area of a bezel 190. For example, an IR sensor for iris authentication may be exposed through one area of the display 110, or be exposed through one area of the bezel 190.

In one embodiment, at least one front camera 161 may be disposed in a second area 160 of the front surface of the electronic device 100. In the embodiment of FIG. 1, a front camera 161 is shown as being exposed through one area of the display 110, but in another embodiment, the front camera 161 may be exposed through the bezel 190. According to a non-limiting embodiment, the electronic device 100 may include two front cameras such as a first front camera and a second front camera. In one embodiment, the first front camera and the second front camera may be cameras of the same type having the same specification (e.g., pixel), but the first front camera and the second front camera may be implemented as cameras having different specifications. The electronic device 100 may support a function related to a dual camera (e.g., 3D shooting, auto focus, etc.) through two front cameras. The description of the aforementioned front camera may be equally or similarly applied to a rear camera of the electronic device 100.

In one embodiment, the electronic device 100 may additionally include various types of hardware or sensors 163 that assist shooting, such as a flash. For example, a distance sensor (e.g., a TOF sensor) for detecting a distance between a subject and the electronic device 100 may be further included. The distance sensor may be applied to both a front camera and/or a rear camera. The distance sensor may be separately disposed or included, and be disposed in the front camera and/or the rear camera.

In one embodiment, at least one physical key may be disposed in a side portion of the electronic device 100. For example, a first function key 151 for turning on/off the display 110 or turning on/off the power of the electronic device 100 may be disposed on a right edge of the front surface of the electronic device 100. In one embodiment, a second function key 152 for controlling a volume or controlling a screen brightness, etc. of the electronic device 100 may be disposed on a left edge of the front surface of the electronic device 100. In addition to this, an additional button or key may also be disposed on the front surface or rear surface of the electronic device 100. For example, a physical button or touch button mapped to a specific function may be disposed in a lower area of the front bezel 190.

The electronic device 100 shown in FIG. 1 corresponds to one example, and does not limit a shape of a device to which the technical spirit disclosed in the present disclosure is applied. For example, the technical spirit of the present disclosure may also be applied to a foldable electronic device capable of being folded horizontally or vertically by adopting a flexible display and a hinge structure, a rollable electronic device capable of rolling, a tablet or a laptop. In addition, the present technical spirit may be applied even when the first camera and the second camera facing the same direction are possible to be disposed to face different directions through the rotation, folding, deformation, etc. of the device.

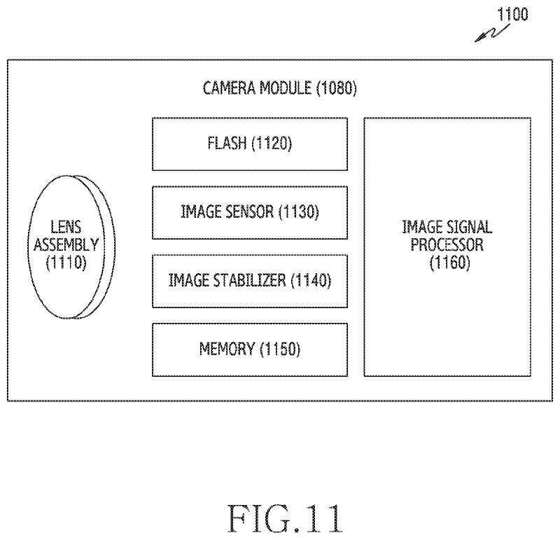

Referring to FIG. 1, the electronic device (e.g., an electronic device 1001 of FIG. 10) 100 of an embodiment may include the camera (e.g., a camera module 1080 of FIG. 10) 180. The camera 180 may include a lens assembly (e.g., a lens assembly 1110 of FIG. 11) 111, a housing 113, an infrared cut filter 115, an image sensor (e.g., an image sensor 1130 of FIG. 11) 120, and an image signal processor (e.g., an image signal processor 1160 of FIG. 11) 130.

In one embodiment, the lens assembly 111 may have different numbers, arrangements, types, etc. of lenses according to the front camera and the rear camera. Depending on the type of the lens assembly, the front camera and the rear camera may have different characteristics (e.g., focal length, maximum magnification, etc.). The lens may be moved forward and backward along an optical axis, and may be operated wherein a target object, a subject, may be clearly photographed by changing a focal length.

In one embodiment, the camera 180 may include the housing 113 mounting a lens barrel mounting at least one or more lenses aligned on an optical axis and at least one coil surrounding the lens barrel around the optical axis.

In one embodiment, the infrared cut filter 115 may be disposed on an upper surface of the image sensor 120. An image of a subject passing through the lens may be partially filtered by the infrared cut filter 115 and then be detected by the image sensor 120.

In one embodiment, the image sensor 120 may be disposed on an upper surface of a printed circuit board 140. The image sensor 120 may be electrically connected to the image signal processor 130 connected to the printed circuit board 140 through a connector. A flexible printed circuit board (FPCB) or a cable, etc. may be used as the connector.

In one embodiment, the image sensor 120 may be a complementary metal oxide semiconductor (CMOS) sensor or a charged coupled device (CCD) sensor. A plurality of individual pixels are integrated in the image sensor 120, and each individual pixel may include a micro lens, a color filter, and a photodiode. Each individual pixel, which is a kind of photodetector, may convert input light into an electrical signal. The photodetector generally may not detect a wavelength of captured light by itself and may not determine color information. The photodetector may include a photodiode.

In one embodiment, light information of a subject incident through the lens assembly 111 may be converted into an electrical signal by the image sensor 120 and be inputted to the image signal processor 130.

In one embodiment, the camera 180 may be disposed on the front surface as well as the rear surface of the electronic device 100. Also, the electronic device 100 may include not only one camera 180 but also multiple cameras 180 so as to improve camera performance. For example, the electronic device 100 may further include the front camera 161 for video call or self-camera shoot (sometimes referred to as a self-portrait photograph or self-portrait digital image). The front camera 161 may support a relatively low number of pixels compared to a rear camera module. The front camera may be relatively smaller than the rear camera module.

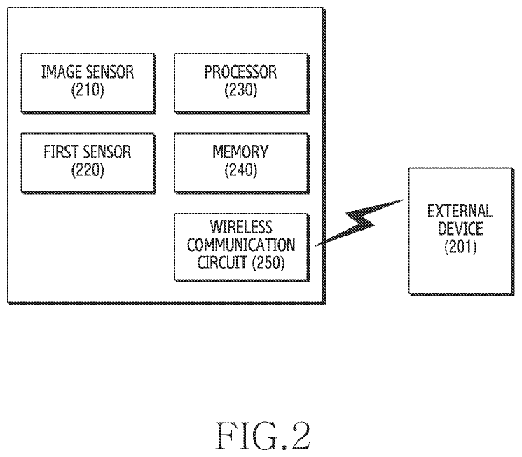

FIG. 2 illustrates a main construction of an electronic device and an external device according to an embodiment. In a description of FIG. 2, the construction described in FIG. 1 may be briefly described, or a description may be omitted.

Referring to FIG. 2, the electronic device 100 may include an image sensor 210, at least one first sensor 220, a processor 230, a memory 240, and a wireless communication circuit 250. The image sensor 210, which is a sensor acquiring image data, may correspond to the image sensor 120 of FIG. 1.

In one embodiment, the at least one first sensor 220 may be referred to as an “object sensor”, which may acquire motion information about an object detected in the image data. In one embodiment, the at least one first sensor 220 (i.e., object sensor 220) is an image sensor for acquiring motion information of the object, and may be at least one of a depth sensor and/or a dynamic vision sensor (DVS). In one embodiment, the first sensor 220 may be a second image sensor distinct from the image sensor 210. The second image sensor may acquire data at a higher rate than the first image sensor 210 in order to acquire the motion information about the object.

In one embodiment, the memory 240 may store image data acquired through the image sensor 210 and/or motion information about an object acquired through the first sensor 220.

In one embodiment, the external device 201 may be a tablet or notebook PC of the same user. The external device 201 may be a server connected to the electronic device 100. The external device 201 may be a device that performs operations described in the present specification.

In one embodiment, the electronic device 100 may establish a wireless communication connection with the external device 201 through the wireless communication circuit 250. The electronic device 100 may transmit data to the external device 201 through the wireless communication circuit 250. For example, the electronic device 100 may transmit image data to the external device 201 through the wireless communication circuit 250. For example, the electronic device 100 may transmit information about an object detected in the image data, to the external device 201 through the wireless communication circuit 250. For example, the electronic device 100 may transmit a package file which includes the image data and the information about the object, to the external device 201 through the wireless communication circuit 250.

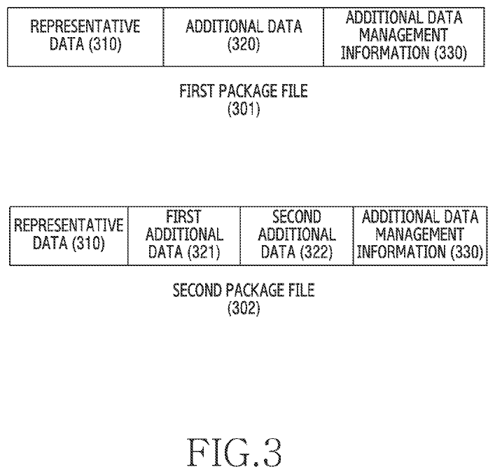

FIG. 3 illustrates a package file according to an embodiment. Representative data of FIG. 3 may be understood as image data comprising an object, and additional data may be understood as motion information about the object comprised in the image data. The package file (e.g., first package file 301 and second package file 302) may be transmitted from the electronic device 100 to the external device 201 by the unit of one file, i.e., a single combined filed including both the first package file 301 and the second package file 302.

Referring to FIG. 3, the processor 230 may generate the first package file 301 by configuring representative data 310 acquired through the image sensor 210 and additional data 320 acquired through the first sensor 220 into one package. The processor 230 may provide and transmit the first package file 301 to the external device 201. In one embodiment, the first package file 301 may include the representative data 310 and the additional data 320. The first package file 301 may include additional data management information 330. The additional data management information 330 may be information about a storage format of the additional data 320.

In one embodiment, the additional data 320 may include motion information about an object acquired through at least one object sensor (e.g., the first sensor 220). The additional data 320 may include vector information for each image region processed based on the motion information. The additional data 320 may include segmentation information of an object processed based on the image data and the motion information. The additional data 320 may include information about a relationship between time when the image data and the motion information are acquired. A description of the additional data 320 may be equally or similarly applied to the first additional data 321 and the second additional data 322.

In one embodiment, the processor 230 may generate the second package file 302 including representative data 310, a plurality of additional data 321 and 321, and additional data management information 330. The processor 230 may provide and transmit the second package file 302 to the external device 201. The second package file 302 may include the first additional data 321 and the second additional data 322. For example, the first additional data 321 may include motion information about an object. For example, the second additional data 322 may include link information for accessing the motion information, without including actual data. In other words, the second additional data 322 may include link information accessible to the external device 201 in which data is stored, without directly storing the corresponding data, in order to save a storage capacity.

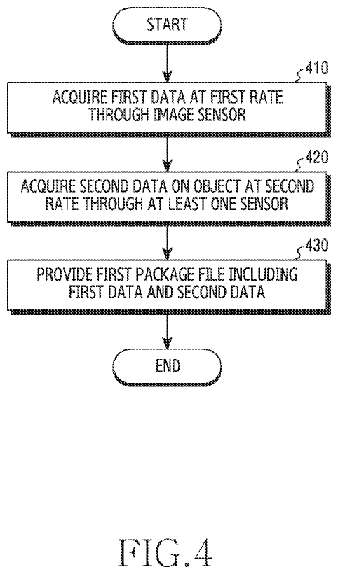

FIG. 4 is a flowchart illustrating a process of providing a package file including image data and data on motion information of an object in an electronic device according to an embodiment.

In operation 410 of one embodiment, the processor 230 may acquire first data through a first image sensor (e.g., the image sensor 210 of FIG. 2). The processor 230 may acquire the first data at a first rate. For example, the processor 230 may acquire image data at 30 fps through the first image sensor 210.

In operation 420 of one embodiment, the processor 230 may acquire second data on an object at a second rate through at least one sensor. The at least one sensor may acquire information about an object included in the image data.

In one embodiment, the second data may be data corresponding to the first data. In other words, the second data may be motion information acquired from a time point when the first data (e.g., image data) starts to be acquired until a time point when the acquisition is completed. The ‘from the time point of starting acquisition until the time point of completion of acquisition’ may be understood as ‘from a time point when light is exposed to the image sensor and data starts to be acquired until a time point when exposure of one frame is completed’. Alternatively, the ‘from the time point of starting acquisition until the time point of completion of acquisition’ may be understood as ‘from a time point of starting read-out until a time point of completing the read-out’.

In one embodiment, the processor 230 may acquire motion information of an object through a dynamic vision sensor (DVS). The dynamic vision sensor may acquire the motion information of the object by the unit of pixel rather than the unit of frame. The processor 230 may acquire edge information of the object detected through the dynamic vision sensor.

In one embodiment, the processor 230 may acquire motion information of an object through a depth sensor. The processor 230 may distinguish objects, based on a depth value of each object, and check the motion of the corresponding object.

In one embodiment, the processor 230 may acquire motion information of an object through the second image sensor. The second image sensor may acquire image data at a higher speed than the first image sensor. For example, while the first image sensor 210 acquires image data at 30 fps, the second image sensor 210 may acquire image data at 60 fps. The second image sensor may acquire motion information of an object included in the image data, by acquiring data at a higher speed than the first image sensor.

In operation 430 of one embodiment, the processor 230 may provide a first package file including the first data and the second data. The first package file may include image data and motion information corresponding to the image data.

In one embodiment, the processor 230 may perform image processing on the image data acquired based on the first package file. For example, the processor 230 may perform image processing on the image data, based on the image data (e.g., image data) and second data (e.g., object motion information) included in the first package file. The processor 230 may display an image on which the image processing has been performed, through the display 110.

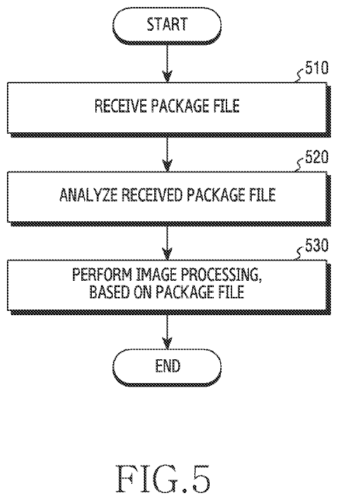

FIG. 5 is a flowchart illustrating a process of receiving a package file and performing image processing in an electronic device according to an embodiment.

In operation 510 of one embodiment, the processor 230 may receive a package file. The processor 230 may acquire the package file from the external device 201. The package file may correspond to the first package file 301 and/or the second package file 302 of FIG. 3.

In operation 520 of one embodiment, the processor 230 may analyze the received package file. The processor 230 may analyze the package file acquired from the external device 201. The processor 230 may analyze image data and object motion information configured in the package file. The processor 230 may check a trajectory of an object included in the image data while acquiring the image data. For example, the processor 230 may check a trajectory of an object, based on motion information acquired while light is exposed to an image sensor and image data is acquired.

In operation 530 of one embodiment, the processor 230 may perform image processing, based on the package file. The processor 230 may perform image processing on the image data by using the package file including the motion information about the object. For example, the processor 230 may correct blur caused by the motion of the object. For example, the processor 230 may perform editing on each object, based on the object motion information.

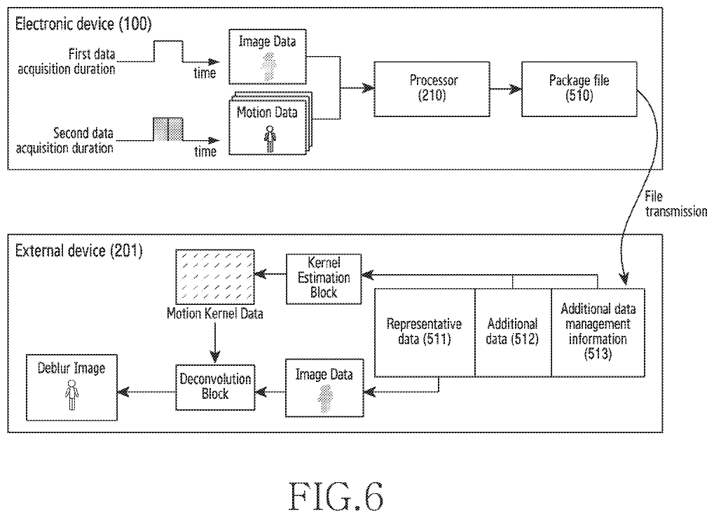

FIG. 6 is a diagram illustrating a process of providing a package file in an electronic device, delivering the package file to an external device, and performing image processing based on a package file received from the external device, according to a non-limiting embodiment. Operations performed in the external device 201 may also be performed in the electronic device 100. In other words, the electronic device 100 may perform image processing, based on a package file transmitted from the external device 201.

Referring to FIG. 6, the electronic device 100 may acquire image data (e.g., image data) and second data (e.g., object motion information). While acquiring the image data, the electronic device 100 may acquire second data corresponding to the image data. The electronic device 100 may acquire one image data for a first time, and acquire a plurality of second data for the first time. The processor 230 may provide a package file 610, based on the acquired image data and second data. The processor 230 may transmit the package file 610 to the external device 201.

In the present disclosure, a unit of first data corresponding to one image may be referred to as a first frame. In the present disclosure, a unit of second data corresponding the image may be referred to as a second frame. For example, a unit of second data including motion information (e.g., motion vectors) for one image may be referred to as the second frame. In one embodiment, the processor 230 may acquire a plurality of second frames for the first time to acquire one first frame.

In one embodiment, the external device 201 may receive the package file 610. The second data comprises information to perform image processing on the first data (an image). The external device 201 may analyze the received package file 610. The external device 201 may analyze representative data (e.g., image data) 611, additional data (e.g., object motion information) 612, and additional data management information 613 included in the package file 610, and use them for image processing. For example, the external device 201 may analyze a moving trajectory of an object while an image is captured, based on the image data and the object motion information.

In one embodiment, the external device 201 may acquire the representative data (e.g., image data) included in the package file 610. The external device 201 may divide the acquired image data into a plurality of regions.

In one embodiment, the external device 201 may extract motion information, based on at least the additional data 612, and/or the additional data management information 613, included in the package file 610. The external device 201 may extract the motion information included in the additional data from a kernel estimation block. The external device 201 may extract vector information for each image region that is based on the motion information. The external device 201 may acquire motion kernel data of the plurality of regions, of which one or more of the regions may contain a blurred portion.

In one embodiment, the external device 201 may deconvolute the acquired motion kernel data by each of the plurality of regions of the image data. The external device 100 may restore (e.g., deblurring) a blurred portion by each of the plurality of regions. By combining the restored regions, the external device 201 may provide a resulting image on which image processing has been performed. The external device 201 may output the resulting image on which the image processing has been performed, through a display.

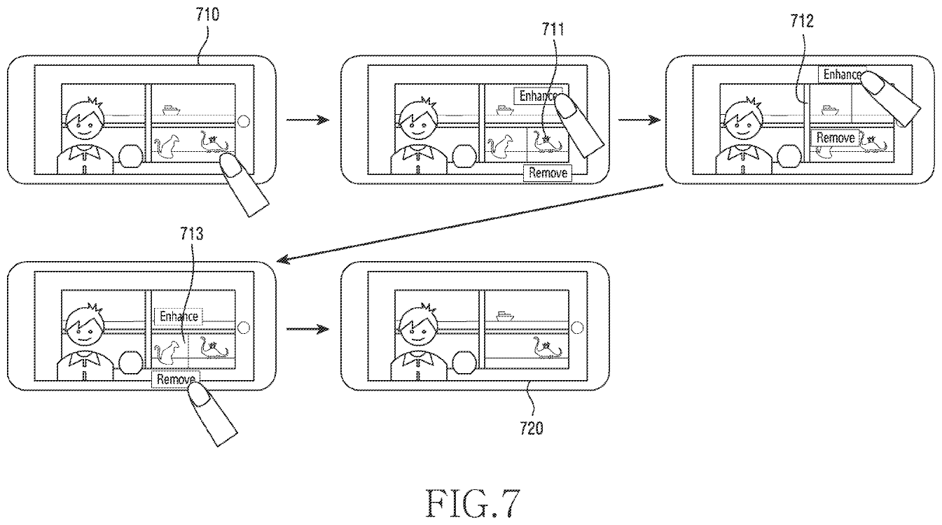

FIG. 7 illustrates image editing with respect to a preview image in an electronic device according to an embodiment. FIG. 7 shows that, when capturing an image, the processor 230 edits the image in real time by dividing and integrating a subject in a preview mode.

In one embodiment, the processor 230 may acquire image data through the camera 180, and display a preview image, based on the acquired image data. The processor 230 may output the preview image through one area of a display. In response to a user's selection of a capture button, the processor 230 may capture a preview image and display the captured image 710 on the display. The captured image 710 may include a plurality of objects. The plurality of objects may be distinguished based on respective motion information (e.g., DVS information) and depth information.

In one embodiment, in response to a user's input of selecting a first object 711, the processor 230 may present an option for the first object 711. For example, the processor 230 may present an interface indicating a function such as enhancing an image quality of the first object 711 and/or removing the first object 711.

In one embodiment, in response to a user's input of selecting a second object 712, the processor 230 may present an option for the second object 712. For example, the processor 230 may present an interface indicating a function such as enhancing an image quality of the second object 712 and/or removing the second object 712.

In one embodiment, in response to a user's input of selecting a third object 713, the processor 230 may present an option for the third object 713. For example, the processor 230 may present an interface indicating a function such as enhancing an image quality of the third object 713 and/or removing the third object 713.

In one embodiment, the processor 230 may perform editing on an object selected by a user. The processor 230 may display a resulting image on which the editing has been performed. The processor 230 may display a resulting image 720 on which editing of the first object 711 to the third object 713 has been performed. For example, the processor 230 may display the resulting image 720 in which the quality of the first object 711 and second object 712 is enhanced in a captured image and the third object 713 is removed.

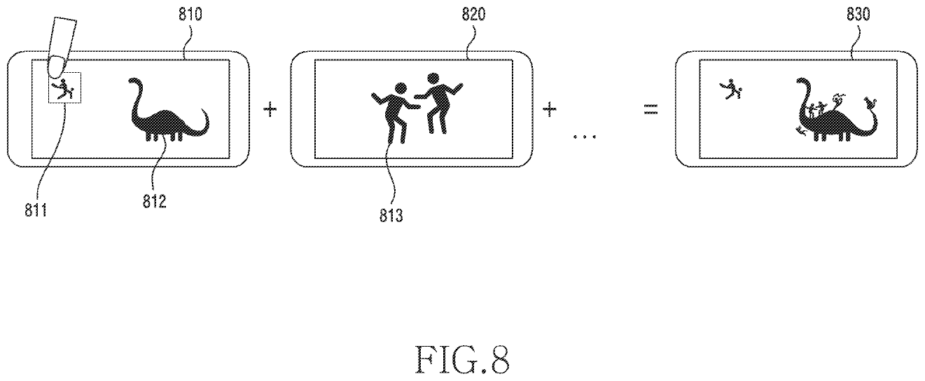

FIG. 8 illustrates editing of one image stored in an electronic device according to an embodiment. FIG. 8 illustrates editing an image in real time by dividing and integrating a subject, based on a plurality of images among images already stored in the electronic device 100.

In one embodiment, the processor 230 may select a plurality of images stored in the memory 240. The processor 230 may select at least two images from among a plurality of images stored in a gallery application according to a user's selection. For example, the processor 230 may determine a first image 810 and a second image 820 according to a user's selection.

In one embodiment, each of the plurality of images may include at least one object. For example, the first image 810 may include a first object 811 and a second object 812, and the second image 820 may include a third object 813. Each object may be classified based on motion information (e.g., DVS information) and/or depth information.

In one embodiment, the processor 230 may provide a resulting image 830 by editing an object selected from the plurality of images. For example, the processor 230 may determine the first image 810 among a plurality of images, as a base image. In response to a user's selection, the processor 230 may separate the first object 811 and the second object 812 included in the first image 810. In response to a user's selection, the processor 230 may separate the third object 813 included in the second image 820. In one embodiment, the processor 230 may provide and display the resulting image 830 in which the first object 811 to the third object 813 are integrated.

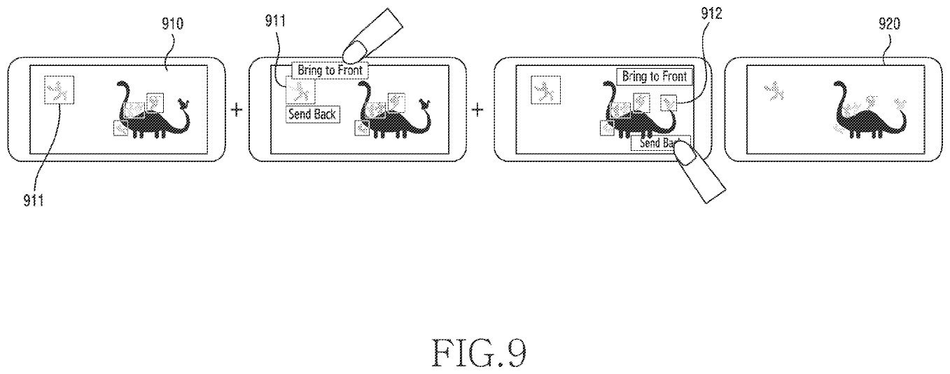

FIG. 9 illustrates editing of a plurality of images stored in an electronic device according to an embodiment. FIG. 9 illustrates editing an image in real time by dividing and integrating a subject, based on a plurality of images already stored in the electronic device 100. Referring to FIG. 9, when editing an image, the processor 230 may arrange an object, based on depth information of the object. Through this, the processor 230 may provide a more natural and three-dimensional resulting image.

In one embodiment, the processor 230 may select a plurality of images stored in the memory 240. The processor 230 may select at least two images from among a plurality of images stored in a gallery application according to a user's selection. Each of the plurality of images may include at least one object. Each object may be classified based on motion information (e.g., DVS information) and/or depth information. The processor 230 may provide the first image 910 by integrating an object selected from the plurality of images.

In one embodiment, the processor 230 may provide a resulting image by reflecting depth information about a plurality of objects included in a first image 910. The processor 230 may present an option for the plurality of objects. For example, the processor 230 may present an interface for selecting a sense of distance for a selected object. For example, the processor 230 may acquire an input of ‘Bring to front’ for a first object 911 and an input of ‘Send back’ for a second object 912.

In one embodiment, the processor 230 may arrange an object, based on a user's input of selecting the sense of distance. By arranging the object, the processor 230 may provide a resulting image 920. The processor 230 may display the resulting image 920 on which editing on the sense of distance has been performed, on the display 110.

FIG. 10 is a block diagram illustrating an electronic device 1001 in a network environment 1000 according to various embodiments.

Referring to FIG. 10, the electronic device 1001 in the network environment 1000 may communicate with an electronic device 1002 via a first network 1098 (e.g., a short-range wireless communication network), or at least one of an electronic device 1004 or a server 1008 via a second network 1099 (e.g., a long-range wireless communication network). According to an embodiment, the electronic device 1001 may communicate with the electronic device 1004 via the server 1008. According to an embodiment, the electronic device 1001 may include a processor 1020, memory 1030, an input module 1050, a sound output module 1055, a display module 1060, an audio module 1070, a sensor module 1076, an interface 1077, a connecting terminal 1078, a haptic module 1079, a camera module 1080, a power management module 1088, a battery 1089, a communication module 1090, a subscriber identification module(SIM) 1096, or an antenna module 1097. In some embodiments, at least one of the components (e.g., the connecting terminal 1078) may be omitted from the electronic device 1001, or one or more other components may be added in the electronic device 1001. In some embodiments, some of the components (e.g., the sensor module 1076, the camera module 1080, or the antenna module 1097) may be implemented as a single component (e.g., the display module 1060).

The processor 1020 may execute, for example, software (e.g., a program 1040) to control at least one other component (e.g., a hardware or software component) of the electronic device 1001 coupled with the processor 1020, and may perform various data processing or computation. According to one embodiment, as at least part of the data processing or computation, the processor 1020 may store a command or data received from another component (e.g., the sensor module 1076 or the communication module 1090) in volatile memory 1032, process the command or the data stored in the volatile memory 1032, and store resulting data in non-volatile memory 1034. According to an embodiment, the processor 1020 may include a main processor 1021 (e.g., a central processing unit (CPU) or an application processor (AP)), or an auxiliary processor 1023 (e.g., a graphics processing unit (GPU), a neural processing unit (NPU), an image signal processor (ISP), a sensor hub processor, or a communication processor (CP)) that is operable independently from, or in conjunction with, the main processor 1021. For example, when the electronic device 1001 includes the main processor 1021 and the auxiliary processor 1023, the auxiliary processor 1023 may be adapted to consume less power than the main processor 1021, or to be specific to a specified function. The auxiliary processor 1023 may be implemented as separate from, or as part of the main processor 1021.

The auxiliary processor 1023 may control at least some of functions or states related to at least one component (e.g., the display module 1060, the sensor module 1076, or the communication module 1090) among the components of the electronic device 1001, instead of the main processor 1021 while the main processor 1021 is in an inactive (e.g., sleep) state, or together with the main processor 1021 while the main processor 1021 is in an active state (e.g., executing an application). According to an embodiment, the auxiliary processor 1023 (e.g., an image signal processor or a communication processor) may be implemented as part of another component (e.g., the camera module 1080 or the communication module 1090) functionally related to the auxiliary processor 1023. According to an embodiment, the auxiliary processor 1023 (e.g., the neural processing unit) may include a hardware structure specified for artificial intelligence model processing. An artificial intelligence model may be generated by machine learning. Such learning may be performed, e.g., by the electronic device 1001 where the artificial intelligence is performed or via a separate server (e.g., the server 1008). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 1030 may store various data used by at least one component (e.g., the processor 1020 or the sensor module 1076) of the electronic device 1001. The various data may include, for example, software (e.g., the program 1040) and input data or output data for a command related thererto. The memory 1030 may include the volatile memory 1032 or the non-volatile memory 1034.

The program 1040 may be stored in the memory 1030 as software, and may include, for example, an operating system (OS) 1042, middleware 1044, or an application 1046.

The input module 1050 may receive a command or data to be used by another component (e.g., the processor 1020) of the electronic device 1001, from the outside (e.g., a user) of the electronic device 1001. The input module 1050 may include, for example, a microphone, a mouse, a keyboard, a key (e.g., a button), or a digital pen (e.g., a stylus pen).

The sound output module 1055 may output sound signals to the outside of the electronic device 1001. The sound output module 1055 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 1060 may visually provide information to the outside (e.g., a user) of the electronic device 1001. The display module 1060 may include, for example, a display, a hologram device, or a projector and control circuitry to control a corresponding one of the display, hologram device, and projector. According to an embodiment, the display module 1060 may include a touch sensor adapted to detect a touch, or a pressure sensor adapted to measure the intensity of force incurred by the touch.

The audio module 1070 may convert a sound into an electrical signal and vice versa. According to an embodiment, the audio module 1070 may obtain the sound via the input module 1050, or output the sound via the sound output module 1055 or a headphone of an external electronic device (e.g., an electronic device 1002) directly (e.g., wiredly) or wirelessly coupled with the electronic device 1001.

The sensor module 1076 may detect an operational state (e.g., power or temperature) of the electronic device 1001 or an environmental state (e.g., a state of a user) external to the electronic device 1001, and then generate an electrical signal or data value corresponding to the detected state. According to an embodiment, the sensor module 1076 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1077 may support one or more specified protocols to be used for the electronic device 1001 to be coupled with the external electronic device (e.g., the electronic device 1002) directly (e.g., wiredly) or wirelessly. According to an embodiment, the interface 1077 may include, for example, a high definition multimedia interface (HDMI), a universal serial bus (USB) interface, a secure digital (SD) card interface, or an audio interface.

A connecting terminal 1078 may include a connector via which the electronic device 1001 may be physically connected with the external electronic device (e.g., the electronic device 1002). According to an embodiment, the connecting terminal 1078 may include, for example, a HDMI connector, a USB connector, a SD card connector, or an audio connector (e.g., a headphone connector).

The haptic module 1079 may convert an electrical signal into a mechanical stimulus (e.g., a vibration or a movement) or electrical stimulus which may be recognized by a user via his tactile sensation or kinesthetic sensation. According to an embodiment, the haptic module 1079 may include, for example, a motor, a piezoelectric element, or an electric stimulator.

The camera module 1080 may capture a still image or moving images. According to an embodiment, the camera module 1080 may include one or more lenses, image sensors, image signal processors, or flashes.

The power management module 1088 may manage power supplied to the electronic device 1001. According to one embodiment, the power management module 1088 may be implemented as at least part of, for example, a power management integrated circuit (PMIC).

The battery 1089 may supply power to at least one component of the electronic device 1001. According to an embodiment, the battery 1089 may include, for example, a primary cell which is not rechargeable, a secondary cell which is rechargeable, or a fuel cell.

The communication module 1090 may support establishing a direct (e.g., wired) communication channel or a wireless communication channel between the electronic device 1001 and the external electronic device (e.g., the electronic device 1002, the electronic device 1004, or the server 1008) and performing communication via the established communication channel. The communication module 1090 may include one or more communication processors that are operable independently from the processor 1020 (e.g., the application processor (AP)) and supports a direct (e.g., wired) communication or a wireless communication. According to an embodiment, the communication module 1090 may include a wireless communication module 1092 (e.g., a cellular communication module, a short-range wireless communication module, or a global navigation satellite system (GNSS) communication module) or a wired communication module 1094 (e.g., a local area network (LAN) communication module or a power line communication (PLC) module). A corresponding one of these communication modules may communicate with the external electronic device via the first network 1098 (e.g., a short-range communication network, such as Bluetooth™, wireless-fidelity (Wi-Fi) direct, or infrared data association (IrDA)) or the second network 1099 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 1092 may identify and authenticate the electronic device 1001 in a communication network, such as the first network 1098 or the second network 1099, using subscriber information (e.g., international mobile subscriber identity (IMSI)) stored in the subscriber identification module 1096.

The wireless communication module 1092 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 1092 may support a high-frequency band (e.g., the mmWave band) to achieve, e.g., a high data transmission rate. The wireless communication module 1092 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 1092 may support various requirements specified in the electronic device 1001, an external electronic device (e.g., the electronic device 1004), or a network system (e.g., the second network 1099). According to an embodiment, the wireless communication module 1092 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of lms or less) for implementing URLLC.

The antenna module 1097 may transmit or receive a signal or power to or from the outside (e.g., the external electronic device) of the electronic device 1001. According to an embodiment, the antenna module 1097 may include an antenna including a radiating element composed of a conductive material or a conductive pattern formed in or on a substrate (e.g., a printed circuit board (PCB)). According to an embodiment, the antenna module 1097 may include a plurality of antennas (e.g., array antennas). In such a case, at least one antenna appropriate for a communication scheme used in the communication network, such as the first network 1098 or the second network 1099, may be selected, for example, by the communication module 1090 (e.g., the wireless communication module 1092) from the plurality of antennas. The signal or the power may then be transmitted or received between the communication module 1090 and the external electronic device via the selected at least one antenna. According to an embodiment, another component (e.g., a radio frequency integrated circuit (RFIC)) other than the radiating element may be additionally formed as part of the antenna module 1097.

According to various embodiments, the antenna module 1097 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1001 and the external electronic device 1004 via the server 1008 coupled with the second network 1099. Each of the electronic devices 1002 or 1004 may be a device of a same type as, or a different type, from the electronic device 1001. According to an embodiment, all or some of operations to be executed at the electronic device 1001 may be executed at one or more of the external electronic devices 1002, 1004, or 1008. For example, if the electronic device 1001 should perform a function or a service automatically, or in response to a request from a user or another device, the electronic device 1001, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1001. The electronic device 1001 may provide the outcome, with or without further processing of the outcome, as at least part of a reply to the request. To that end, a cloud computing, distributed computing, mobile edge computing (MEC), or client-server computing technology may be used, for example. The electronic device 1001 may provide ultra low-latency services using, e.g., distributed computing or mobile edge computing. In another embodiment, the external electronic device 1004 may include an internet-of-things (IoT) device. The server 1008 may be an intelligent server using machine learning and/or a neural network. According to an embodiment, the external electronic device 1004 or the server 1008 may be included in the second network 1099. The electronic device 1001 may be applied to intelligent services (e.g., smart home, smart city, smart car, or healthcare) based on 5G communication technology or IoT-related technology.

FIG. 11 is a block diagram 1100 illustrating the camera module 1080 according to various embodiments.

Referring to FIG. 11, the camera module 1080 may include a lens assembly 1110, a flash 1120, an image sensor 1130, an image stabilizer 1140, memory 1150 (e.g., buffer memory), or an image signal processor 1160. The lens assembly 1110 may collect light emitted or reflected from an object whose image is to be taken. The lens assembly 1110 may include one or more lenses. According to an embodiment, the camera module 1080 may include a plurality of lens assemblies 1110. In such a case, the camera module 1080 may form, for example, a dual camera, a 360-degree camera, or a spherical camera. Some of the plurality of lens assemblies 1110 may have the same lens attribute (e.g., view angle, focal length, auto-focusing, f number, or optical zoom), or at least one lens assembly may have one or more lens attributes different from those of another lens assembly. The lens assembly 1110 may include, for example, a wide-angle lens or a telephoto lens.

The flash 1120 may emit light that is used to reinforce light reflected from an object. According to an embodiment, the flash 1120 may include one or more light emitting diodes (LEDs) (e.g., a red-green-blue (RGB) LED, a white LED, an infrared (IR) LED, or an ultraviolet (UV) LED) or a xenon lamp. The image sensor 1130 may obtain an image corresponding to an object by converting light emitted or reflected from the object and transmitted via the lens assembly 1110 into an electrical signal. According to an embodiment, the image sensor 1130 may include one selected from image sensors having different attributes, such as a RGB sensor, a black-and-white (BW) sensor, an IR sensor, or a UV sensor, a plurality of image sensors having the same attribute, or a plurality of image sensors having different attributes. Each image sensor included in the image sensor 1130 may be implemented using, for example, a charged coupled device (CCD) sensor or a complementary metal oxide semiconductor (CMOS) sensor.

The image stabilizer 1140 may move the image sensor 1130 or at least one lens included in the lens assembly 1110 in a particular direction, or control an operational attribute (e.g., adjust the read-out timing) of the image sensor 1130 in response to the movement of the camera module 1080 or the electronic device 1001 including the camera module 1080. This allows compensating for at least part of a negative effect (e.g., image blurring) by the movement on an image being captured. According to an embodiment, the image stabilizer 1140 may sense such a movement by the camera module 1080 or the electronic device 1001 using a gyro sensor (not shown) or an acceleration sensor (not shown) disposed inside or outside the camera module 1080. According to an embodiment, the image stabilizer 1140 may be implemented, for example, as an optical image stabilizer. The memory 1150 may store, at least temporarily, at least part of an image obtained via the image sensor 1130 for a subsequent image processing task. For example, if image capturing is delayed due to shutter lag or multiple images are quickly captured, a raw image obtained (e.g., a Bayer-patterned image, a high-resolution image) may be stored in the memory 1150, and its corresponding copy image (e.g., a low-resolution image) may be previewed via the display module 1060. Thereafter, if a specified condition is met (e.g., by a user's input or system command), at least part of the raw image stored in the memory 1150 may be obtained and processed, for example, by the image signal processor 1160. According to an embodiment, the memory 1150 may be configured as at least part of the memory 1030 or as a separate memory that is operated independently from the memory 1030.

The image signal processor 1160 may perform one or more image processing with respect to an image obtained via the image sensor 1130 or an image stored in the memory 1150. The one or more image processing may include, for example, depth map generation, three-dimensional (3D) modeling, panorama generation, feature point extraction, image synthesizing, or image compensation (e.g., noise reduction, resolution adjustment, brightness adjustment, blurring, sharpening, or softening). Additionally or alternatively, the image signal processor 1160 may perform control (e.g., exposure time control or read-out timing control) with respect to at least one (e.g., the image sensor 1130) of the components included in the camera module 1080. An image processed by the image signal processor 1160 may be stored back in the memory 1150 for further processing, or may be provided to an external component (e.g., the memory 1030, the display module 1060, the electronic device 1002, the electronic device 1004, or the server 1008) outside the camera module 1080. According to an embodiment, the image signal processor 1160 may be configured as at least part of the processor 1020, or as a separate processor that is operated independently from the processor 1020. If the image signal processor 1160 is configured as a separate processor from the processor 1020, at least one image processed by the image signal processor 1160 may be displayed, by the processor 1020, via the display module 1060 as it is or after being further processed.

According to an embodiment, the electronic device 1001 may include a plurality of camera modules 1080 having different attributes or functions. In such a case, at least one of the plurality of camera modules 1080 may form, for example, a wide-angle camera and at least another of the plurality of camera modules 1080 may form a telephoto camera. Similarly, at least one of the plurality of camera modules 1080 may form, for example, a front camera and at least another of the plurality of camera modules 1080 may form a rear camera.

As described above, an electronic device (e.g., the electronic device 100 of FIG. 2) may include a first image sensor (e.g., the image sensor 210 of FIG. 2) for acquiring image data, at least one sensor (e.g., the first sensor 220 of FIG. 2) for acquiring motion information about an object included in the image data, a memory, and at least one processor (e.g., the processor 230 of FIG. 2) operatively connected to the first image sensor, the at least one sensor and the memory. The at least one processor may acquire image data at a first rate through the first image sensor, acquire, through the at least one sensor, second data on the object at a second rate higher than the first rate, the second data corresponding to the image data and being the data acquired while the image data is acquired, and provide a package file including the acquired image data and second data.

According to an embodiment, the provided package file may be transmitted to an external electronic device or a server.

According to an embodiment, the package file may include management information indicating a data format of the second data.

According to an embodiment, image processing on the image data is performed based on the provided package file.

According to an embodiment, the second data may be a plurality of motion information acquired while the image data is acquired.

According to an embodiment, the package file may be stored in the memory.

According to an embodiment, the at least one sensor may include a second image sensor distinct from the first image sensor.

According to an embodiment, the first image sensor may acquire the image data at a first frame rate, and the second image sensor may acquire motion information of the object at a second frame rate higher than the first frame rate.

According to an embodiment, the electronic device may further include a communication circuit, and the at least one processor may transmit the package file to an external device through the communication circuit.

According to an embodiment, the external device may be a tablet, notebook PC, or server of the same user.

As described above, an operating method of an electronic device may include the operations of acquiring image data at a first rate through a first image sensor, acquiring, through at least one sensor, second data on an object at a second rate higher than the first rate, and providing a package file including the acquired image data and second data.

According to an embodiment, the method may include the operation of transmitting the provided package file to an external electronic device or a server.

According to an embodiment, the method may include the operation of storing the package file in a memory.

According to an embodiment, the method may include the operations of acquiring image data at a first frame rate through the first image sensor, and acquiring motion information of the object at a second frame rate higher than the first frame rate through a second image sensor distinct from the first image sensor.

According to an embodiment, the method may include the operation of performing image processing on the image data, based on the provided package file.

As described above, an electronic device may include a display, and at least one processor operatively connected to the display. The at least one processor may acquire a package file including image data and motion information of an object corresponding to the image data, analyze the package file, and perform image processing on the image data, based on the package file.

According to an embodiment, the electronic device may further include a communication circuit, and the at least one processor may acquire the package file from an external device through the communication circuit.

According to an embodiment, the at least one processor may divide the image data into a plurality of regions, and extract vector information for the motion information by each of the plurality of regions.

According to an embodiment, the at least one processor may perform correction on the object, based on the vector information, by each of the plurality of regions.

According to an embodiment, the at least one processor may display the image data on which the image processing has been performed, on the display.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 1040) including one or more instructions that are stored in a storage medium (e.g., internal memory 1036 or external memory 1038) that is readable by a machine (e.g., the electronic device 1001). For example, a processor (e.g., the processor 1020) of the machine (e.g., the electronic device 1001) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

1. An electronic device comprising:
a first image sensor configured to acquire image data;
at least one object sensor configured to acquire motion information about an object comprised in the image data;
a memory; and
at least one processor operatively connected to the first image sensor, the at least one object sensor, and the memory,
wherein the at least one processor is configured to:
acquire image data at a first rate through the first image sensor;
acquire, through the at least one object sensor, second data on the object at a second rate higher than the first rate, the second data corresponding to the image data and being the data acquired while the image data is acquired; and
provide a package file comprising the acquired image data and second data.

2. The electronic device of claim 1, wherein the at least one processor is configured to:
acquire a first frame comprising the image data, and
acquire a plurality of second frames comprising the second data for a time period to acquire the first frame.

3. The electronic device of claim 2, wherein the second data comprises information usable to perform image processing on the image data.

4. The electronic device of claim 1, wherein the package file is transmitted to an external electronic device or a server.

5. The electronic device of claim 1, wherein the package file comprises management information indicating a data format of the second data.

6. The electronic device of claim 1, wherein the at least one processor performs image processing on the image data based on the package file.

7. The electronic device of claim 1, wherein the package file is stored in the memory.

8. The electronic device of claim 1, wherein the at least one object sensor comprises a second image sensor distinct from the first image sensor.

9. The electronic device of claim 8, wherein
the first image sensor acquires the image data at a first frame rate, and
the second image sensor acquires the motion information of the object at a second frame rate higher than the first frame rate.

10. The electronic device of claim 1, further comprising a communication circuit,
wherein the at least one processor transmits the package file to at least one external device through the communication circuit.

11. The electronic device of claim 10, wherein the at least one external device includes at least one of a tablet, a notebook PC, and a server of the same user.

12. An operating method of an electronic device, the method comprising:
acquiring image data at a first rate through a first image sensor;
acquiring, through at least one object sensor, second data of an object at a second rate higher than the first rate; and
providing a package file comprising the acquired image data and the second data.

13. The method of claim 12, further comprising of transmitting the package file to an external electronic device or a server.

14. The method of claim 12, further comprising storing the package file in a memory.

15. The method of claim 12, further comprising:
acquiring image data at a first frame rate through the first image sensor; and
acquiring motion information of the object at a second frame rate higher than the first frame rate through the at least one object sensor, the at least one object sensor including a second image sensor distinct from the first image sensor.

16. The method of claim 12, further comprising performing image processing on the image data, based on the package file.

17. An electronic device comprising:
a first image sensor configured to acquire representative data corresponding to image data comprising an object;
a second image sensor configured to acquire additional data corresponding to motion information about the object comprised in the image data;
a memory; and
at least one processor operatively connected to the first image sensor, the second image sensor, and the memory,
wherein the at least one processor is configured to:
generate a first package file including the representative data, additional data corresponding to the representative data, and additional management information corresponding to the additional data;
generate a second package file including the representative data, first additional data corresponding to the representative data, second additional data corresponding to the representative data, and additional management information corresponding to at least one of the first additional data and the second additional data; and
combine the first package file with the second package file to generate a combined package file.

18. The electronic device of claim 17, wherein the at least one processor is further configured to:
acquire the representative data at a first rate through the first image sensor; and
acquire, through the second image sensor at a second rate higher than the first rate, at least one of the additional data included in the first packet file, the first additional data included in the second packet file, and the second additional data included in the second packet file.

19. The electronic device of claim 18, wherein the additional data management information comprises information about a storage format of at least one of the additional data included in the first packet file, the first additional data included in the second packet file, and the second additional data included in the second packet file.

20. The electronic device of claim 17, wherein the at least one processor transmits the combined package file to at least one external device.
